(19) United States
(12) Patent Application Publication
(10) Pub. No.: US 2020/0098046 A1
(43) Pub. Date: Mar. 26, 2020

(54) RISK ASSESSMENT TOOL

(71) Applicant: FUNDLAB TECHNOLOGIES INC., Pointe-Claire (CA)

(72) Inventors: John EVANGELIOU, Kirkland (CA); George EVANGELIOU, Kirkland (CA)

(21) Appl. No.: 16/575,885

(22) Filed: Sep. 19, 2019

Related U.S. Application Data
(60) Provisional application No. 62/734,031, filed on Sep. 20, 2018.

(51) Int. Cl. G06Q 40/06; G06Q 40/04

(52) U.S. Cl. CPC G06Q 40/06; G06Q 40/04

(57) ABSTRACT

The present disclosure is drawn to methods and systems for generating a financial tool. A selection of a financial asset is received, the financial asset belonging to one of a plurality of risk groups defining a plurality of risk levels for financial assets. The plurality of risk groups are ranked in accordance with a performance metric. The financial asset is inserted in the ranking in accordance with the performance metric. A common graphical element is assigned to the financial asset and the risk group to which the financial asset belongs, and the plurality of risk groups and the financial asset are displayed as ranked with the common graphical element.

### CROSS-REFERENCE TO RELATED APPLICATIONS

The present application claims the benefit of U.S. Provisional Patent Application No. 62/734,031, filed on Sep. 20, 2018, the entire contents of which are incorporated herein by reference.

### TECHNICAL FIELD

The present disclosure relates to financial tools, and more specifically to digital financial tools for assessing investor risk profiles.

### BACKGROUND OF THE ART

When shopping for financial assets in which to invest, an investor will typically need to first determine their “risk profile”. Conventionally, this is accomplished by having the investor fill out a questionnaire which may span several pages. At the end of the questionnaire, the investor's risk profile indicates which “risk group(s)” of financial assets most accurately reflect their investment goals, and the investor is then presented with different investment options having financial assets belonging to the appropriate risk groups. This is a very subjective exercise, performed not by the investor themselves but by a third party who interprets the investor's answers to the questionnaire.

Presentation of financial assets is traditionally done via various static financial tools, such as paper pamphlets, which are often difficult to read and understand. Additionally, it is not uncommon for certain information, such as share class, to be omitted from such static financial tools, requiring that investors find this information elsewhere, for example via webpages or prospectuses. Often this leads to investors not having adequate information when making investment decisions, and the time required to collect sufficient information leaves prospective investors frustrated.

Specifically, comparison of financial assets against other like assets, allowing for an investor to decide which financial asset is best suited to their needs, can be particularly complicated. Many different investment institutions provide similar financial assets but tend to produce financial tools of different formats, making individual side-by-side comparisons difficult. In addition, because the existing financial tools for investors are static, personalizing the data to a particular investor's risk profile or to their goals is time-consuming and complex, requiring considerable amounts of manual data entry or access to costly private databases and extensive programming knowledge. Existing financial tools also do not provide for large-scale comparisons of a single asset against all other like assets. In short, traditional static financial materials do not allow an investor to properly assess how a particular financial asset matches their risk profile, or how the performance of the financial asset compares to other like assets.

Therefore, there is room for improved financial tools.

### SUMMARY

The present disclosure is drawn to methods and systems for operating a financial tool. A selection of a financial asset is received, the financial asset belonging to one of a plurality of risk groups defining a plurality of risk levels for financial assets. The plurality of risk groups are ranked in accordance with a performance metric. The financial asset is inserted in the ranking in accordance with the performance metric. A common graphical element is assigned to the financial asset and the risk group to which the financial asset belongs, and the plurality of risk groups and the financial asset are displayed as ranked with the common graphical element.

In accordance with a broad aspect, there is provided a method for operating a financial tool, the method comprising: receiving a selection of a financial asset, the financial asset belonging to one of a plurality of risk groups defining a plurality of risk levels for financial assets; ranking the plurality of risk groups in accordance with a performance metric; inserting the financial asset in the ranking in accordance with the performance metric; assigning a common graphical element to the financial asset and the risk group to which the financial asset belongs; and displaying the plurality of risk groups and the financial asset as ranked with the common graphical element.

In some embodiments, the financial asset is one of a mutual fund, a segregated fund, and an Exchange-Traded Fund.

In some embodiments, the performance metric is a rate-of-return over a period of time.

In some embodiments, the risk groups are regulation-compliant.

In some embodiments, the common graphical element is a colour.

In some embodiments, displaying the plurality of risk groups and the financial asset as ranked comprises displaying a chart with a plurality of rows, at least one column, and defining a plurality of cells, each of the at least one columns being representative of a respective time period, and each cell having a respective label indicative of one of one of the risk groups and the financial asset.

In some embodiments, each risk group is colour-coded, wherein displaying the plurality of risk groups and the financial asset as ranked further comprises displaying a risk bar which sorts the colours according to the risk levels from lowest to highest.

In some embodiments, displaying the plurality of risk groups and the financial asset as ranked further comprises displaying an additional column defining a second plurality of cells, each of the second plurality of cells representative of an average.

In some embodiments, displaying the plurality of risk groups and the financial asset as ranked further comprises overlaying a trend line connecting cells having the labels indicative of the financial asset.

In some embodiments, displaying the plurality of risk groups and the financial asset further comprises hiding at least one of the plurality of risk groups.

In some embodiments, the method further comprises changing a time period associated with the ranking.

In some embodiments, the method further comprises subsequent to displaying the plurality of risk groups and the financial asset, receiving an input indicative of deselecting the risk groups; and displaying the financial asset as ranked with the common graphical element.

In some embodiments, displaying the plurality of risk groups and the financial asset as ranked comprises displaying a plurality of interactive elements each associated with a respective one of the plurality of risk groups, the method further comprising, in response to detecting an interaction with one of the plurality of interactive elements, displaying a contextual menu.

In some embodiments, displaying the contextual menu comprises displaying at least one supplementary interactive element, the method further comprises: in response to detecting a supplementary interaction with one of the at least one supplementary interactive elements: receiving a selection of a supplementary financial asset based on the supplementary interaction; inserting the supplementary financial asset in the ranking in accordance with the performance metric; assigning a supplementary common graphical element to the supplementary financial asset based on the risk group to which the financial asset belongs; and displaying the plurality of risk groups, the financial asset, and the supplementary financial asset as ranked with the common graphical element and the supplementary common graphical element.

In accordance with another broad aspect, there is provided a system for operating a financial tool, the system comprising: a processing unit; and a non-transitory memory communicatively coupled to the processing unit and comprising computer-readable program instructions executable by the processing unit for: receiving a selection of a financial asset, the financial asset belonging to one of a plurality of risk groups defining a plurality of risk levels for financial assets; ranking the plurality of risk groups in accordance with a performance metric; inserting the financial asset in the ranking in accordance with the performance metric; assigning a common graphical element to the financial asset and the risk group to which the financial asset belongs; and displaying the plurality of risk groups and the financial asset as ranked with the common graphical element.

In some embodiments, the financial asset is one of a mutual fund, a segregated fund, and an Exchange-Traded Fund.

In some embodiments, the performance metric is a rate-of-return over a period of time.

In some embodiments, the risk groups are regulation-compliant.

In some embodiments, the common graphical element is a colour.

In some embodiments, displaying the plurality of risk groups and the financial asset as ranked comprises displaying a chart with a plurality of rows, at least one column, and defining a plurality of cells, each of the at least one columns being representative of a respective time period, and each cell having a respective label indicative of one of one of the risk groups and the financial asset.

In some embodiments, each risk group is colour-coded, wherein displaying the plurality of risk groups and the financial asset as ranked further comprises displaying a risk bar which sorts the colours according to the risk levels from lowest to highest.

In some embodiments, displaying the plurality of risk groups and the financial asset as ranked further comprises displaying an additional column defining a second plurality of cells, each of the second plurality of cells representative of an average.

In some embodiments, displaying the plurality of risk groups and the financial asset as ranked further comprises overlaying a trend line connecting cells having the labels indicative of the financial asset.

In some embodiments, in displaying the plurality of risk groups and the financial asset further comprises hiding at least one of the plurality of risk groups.

In some embodiments, the computer-readable program instructions are further executable by the processing unit for changing a time period associated with the ranking.

In some embodiments, the computer-readable program instructions are further executable by the processing unit for: subsequent to displaying the plurality of risk groups and the financial asset, receiving an input indicative of deselecting the risk groups; and displaying the financial asset as ranked with the common graphical element.

In some embodiments, displaying the plurality of risk groups and the financial asset as ranked comprises displaying a plurality of interactive elements each associated with a respective one of the plurality of risk groups, the computer-readable program instructions being further executable by the processing unit for, in response to detecting an interaction with one of the plurality of interactive elements, displaying a contextual menu.

In some embodiments, displaying the contextual menu comprises displaying at least one supplementary interactive element, the computer-readable program instructions are further executable by the processing unit for: in response to detecting a supplementary interaction with one of the at least one supplementary interactive elements: receiving a selection of a supplementary financial asset based on the supplementary interaction; inserting the supplementary financial asset in the ranking in accordance with the performance metric; assigning a supplementary common graphical element to the supplementary financial asset based on the risk group to which the financial asset belongs; and displaying the plurality of risk groups, the financial asset, and the supplementary financial asset as ranked with the common graphical element and the supplementary common graphical element.

In accordance with a further broad aspect, there is provided a financial tool comprising: a processing unit configured for: receiving a selection of a financial asset, the financial asset belonging to one of a plurality of risk groups defining a plurality of risk levels for financial assets; ranking the plurality of risk groups in accordance with a performance metric; inserting the financial asset in the ranking in accordance with the performance metric; and assigning a common graphical element to the financial asset and the risk group to which the financial asset belongs; and a display for displaying the plurality of risk groups and the financial asset as ranked with the common graphical element.

In accordance with a further broad aspect, there is provided a method for operating a financial tool, the method comprising: receiving an indication of a portfolio composed of a plurality of financial assets, each of the financial assets belonging to one of a plurality of risk groups defining a plurality of risk levels for financial assets, the portfolio being associated with an aggregate risk level based on the risk groups to which the plurality of financial assets belong; ranking the plurality of risk groups in accordance with a performance metric; inserting the portfolio in the ranking in accordance with the performance metric; assigning a graphical element to the portfolio that is representative of the aggregate risk level of the portfolio, the graphical element based on predetermined graphical elements associated with at least one of the risk groups; and displaying the plurality of risk groups and the financial asset as ranked with the graphical element.

Features of the systems, devices, and methods described herein may be used in various combinations, and may also be used for the system and computer-readable storage medium in various combinations.

### BRIEF DESCRIPTION OF THE DRAWINGS

Further features and advantages of embodiments described herein may become apparent from the following detailed description, taken in combination with the appended drawings, in which:

FIGS. 1A-C are example embodiments of a risk assessment tool.

FIG. 2 is a flowchart illustrating an example method for generating a risk assessment tool.

FIGS. 3A-E are example embodiments of an multi-column risk assessment tool.

FIG. 4 is a schematic diagram of an example computing system for implementing the method of FIG. 3 in accordance with an embodiment.

FIG. 5 is a block diagram of an example implementation of a system for generating a risk assessment tool.

It will be noted that throughout the appended drawings, like features are identified by like reference numerals.

### DETAILED DESCRIPTION

There is provided herein methods and systems for producing and operating risk assessment tools. Such tools present investors with information regarding the relative performance levels of various groups of financial assets over time.

In some embodiments, the financial assets are mutual funds. In Canada, as in many countries, regulations governing mutual funds require that a given mutual fund be assigned to a risk group by the company providing the mutual fund. The risk group must also be approved by a regulatory body, namely the Investment Fund Institute of Canada (IFIC), and the five risk groups are low risk, low-to-medium risk, medium risk, medium-to-high risk, and high risk. Similar regulations exist in many other countries, but the particular risk groups used may vary by jurisdiction and/or regulatory framework. In other jurisdictions, the risk levels may be assigned by data service providers or data brokers, for example on a per-asset category basis and based on a deviation from a mean, median, and the like.

In addition, regulations require that mutual funds belong to a category, based on various factors including asset composition, currency composition, asset geographic location, and the like, and that given mutual funds only be compared against mutual funds belonging to the same category. Moreover, mutual funds belong to a share class, based on the fee structure used to compensate the financial advisor assisting the investor and/or the manager of the fund. Specifically, mutual funds belonging to different share classes have different management expense ratios (MER). For example, commission-based-funds carry the highest MER, and fee-based-funds carry the lowest MERs. In some jurisdictions, mutual funds are compared on the basis of fund performance against the average of the funds of a particular share class, irrespective of the category to which the fund belongs. A common comparison metric is rate-of-return (RoR), which is profit on an investment over a period of time. Another common comparison metric is annualized RoR, which is a geometric average amount of money earned by the mutual fund each year over a given time period. In some embodiments, the risk assessment tool described herein is configured to be compliant with rules and regulations of governing bodies regarding the financial assets to which it relates.

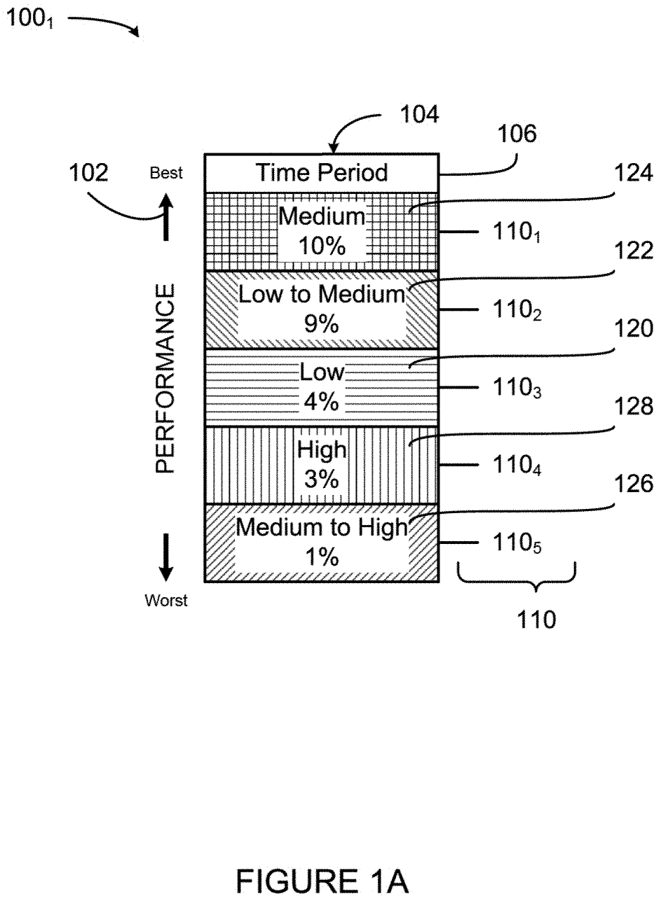

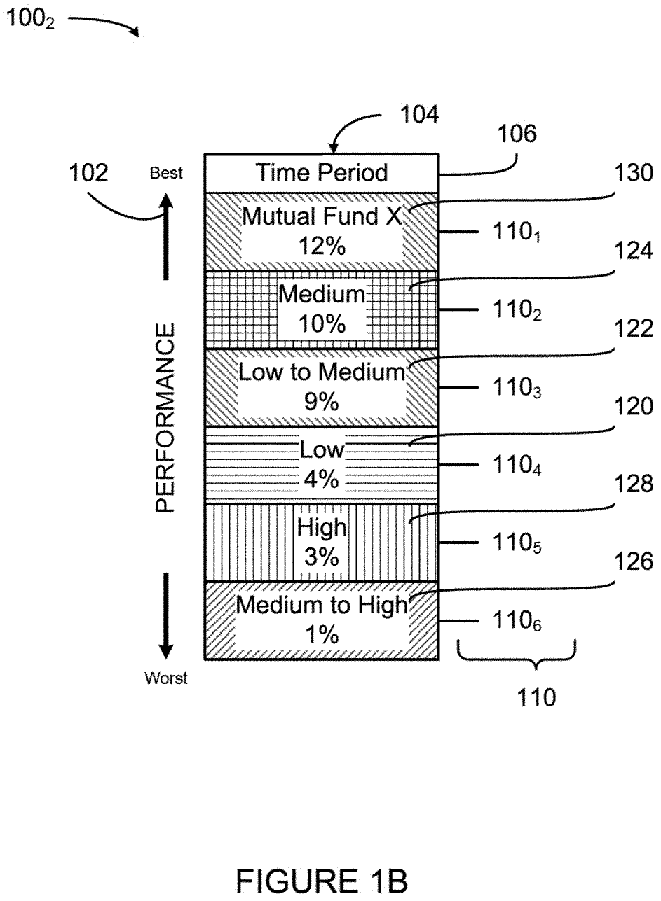

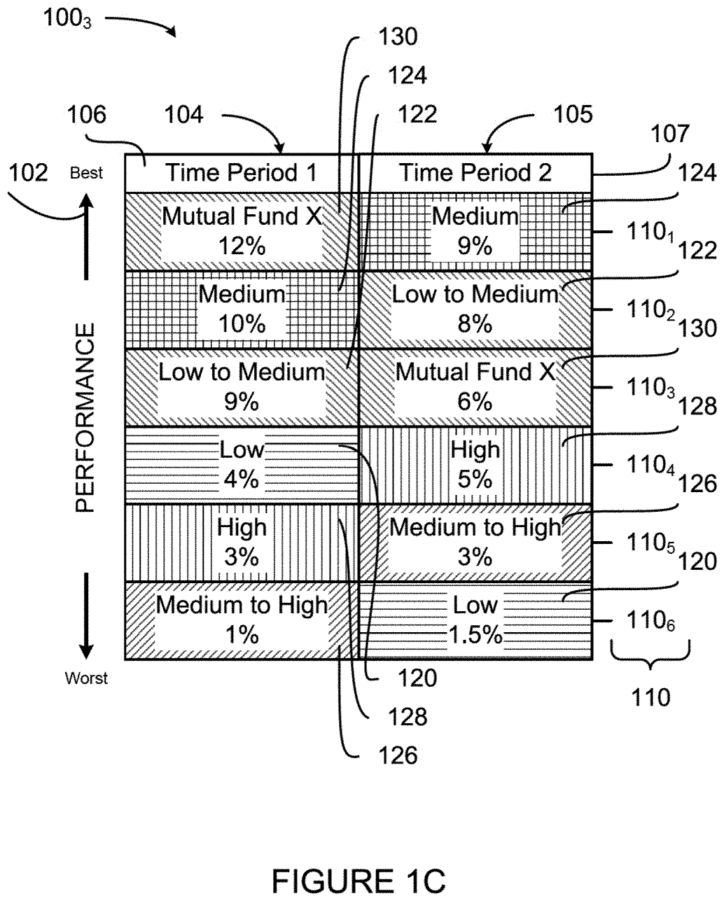

With reference to FIG. 1A, a risk assessment tool (RAT) 100₁ is shown. The RAT 100₁ is a table-like graphical representation which ranks risk groups 120, 122, 124, 126, and 128 of a given share class in order of their performance. The RAT 100₁ arranges the risk groups 120, 122, 124, 126, and 128 based on a performance metric. In the example of FIG. 1A, the arrangement corresponds to a plurality of row entries 110₁-110₆ (collectively the rows 110) of a single column 104, thus defining a plurality of cells. The column 104 includes a column title 106 which indicates a time period which the column represents, as is described in greater detail hereinbelow.

Each of the risk groups 120, 122, 124, 126, and 128 is sorted into a respective cell of one of the row entries 110₁-110₅ of the column 104 based on a dynamic ranking 102. The dynamic ranking 102 ranks the risk groups based on their performance and the performance metric. For example, the dynamic ranking 102 uses an annual RoR as the performance metric. More specifically, each cell within the column 104 is assigned one of the risk groups 120, 122, 124, 126, and 128, and the vertical ordering of the cells follows the dynamic ranking 102 based on the performance of the risk groups 120, 122, 124, 126, and 128 for the given time period indicated by the column title 106. Additionally, each of the row entries 110₁-100₅ includes a graphical element which is representative of the risk group, shown in FIG. 1A via different shadings. Each risk group is associated with a particular graphical element, which in other embodiments may be a colour-coding, a gradient pattern, an animation, or any other suitable visualization.

With reference to FIG. 1B, a second example RAT 100₂ is shown having six row entries 110₁-110₆ in the column 104. In addition to the five risk groups 120, 122, 124, 126, and 128, a selected financial asset 130, called “Mutual Fund X”, is ranked in the RAT 100₂. The selected financial asset 130 can be any financial asset that belongs to the same asset category and/or same share class as the risk groups portrayed in the RAT 100₂. By including the selected financial asset 130 in the RAT 100₂, a visual comparison of the performance of the selected financial asset 130 against the performance of the different risk groups 120, 122, 124, 126, and 128 can be performed. In addition, the selected financial asset also includes a graphical element which is representative of the risk group to which the selected financial asset 130 belongs. Since the selected financial asset 130 belongs to one of the different risk groups 120, 122, 124, 126, and 128, the graphical element of the selected financial asset 130 is shared with the risk group to which the selected financial asset 130 belongs.

In the example of FIG. 1B, the selected financial asset 130 belongs to risk group 122, and the selected financial asset 130 and the risk group 122 share the same graphical element, in this example a shading pattern. The graphical elements used in the RAT 100₁, 100₂ may allow or aid a user of the RAT 100 to recognize the selected financial asset 130 with the particular risk group to which it belongs. In some embodiments, a supplemental graphical element is applied to the selected financial asset 130 in addition to the graphical element shared between the selected financial asset 130 and the risk group to which the selected financial asset 130 belongs. For example, a semi-transparent symbol or mark can be applied to or overlaid on the graphical element shared between the selected financial asset 130 and the risk group to which the selected financial asset 130 belongs. This may allow a user to both associate the selected financial asset to its relevant risk group and discriminate between the relevant risk group and the selected financial asset 130.

The selected financial asset 130 can be any financial asset belonging to the same asset category and/or share class as the risk groups shown in a RAT. In certain jurisdictions, regulations require that a given financial asset only be compared against other like financial assets, for example only against financial assets belonging to the same share class. Thus, the RAT is regulation-compliant insofar as it displays the selected financial asset 130 against the risk groups 120, 122, 124, 126, and 128 for the share class to which the selected financial asset 130 belongs. The selected financial asset 130 can be selected by a user of the RAT, by an investment professional or other financial counselor who is advising an investor, and the like. The selected financial asset 130 can be input in any suitable way, as discussed in greater detail hereinbelow. In some embodiments, the selected financial asset 130 is a particular mutual fund, and the share class is a particular share class of mutual funds to which the particular mutual fund belongs. It should be noted that in other jurisdictions, no restrictions on displaying of financial assets across different asset categories and/or share classes, and the selected financial asset 130 can be any suitable asset. Additionally, in some embodiments the selected financial asset 130 can be a customized portfolio based on a combination of a plurality of financial assets with a particular weighting as provided via user input. Still other embodiments are considered.

The selected financial asset 130 is thus ranked against the different risk groups 120, 122, 124, 126, and 128 of the share class according to the dynamic ranking 102, for example descending order. More specifically, each of the risk groups 120, 122, 124, 126, and 128 and the selected financial asset 130 are illustrated in their respective row entry 110₁-110₆ in the RAT 100₂ by a label or symbol. Each row entry 110₁-110₆ may be represented by a box-like shape, as shown in FIGS. 1A and B. In other embodiments, the row entries 110₁-110₆ may take on other shapes, such as circles, triangles, trapezoids, squares, and the like. In certain embodiments, the row entries 110₁-110₆ share a common shape; in other embodiments, the row entries 110₁-110₆ have differing shapes, and the different shapes can be used to represent additional information, such as mutual fund cost, age of the mutual fund, and the like.

Thus, the RAT 100₂ ranks the selected financial asset 130, in this example Mutual Fund X, against the different risk groups for the share class, namely low risk group 120, low-to-medium risk group 122, medium risk group 124, medium-to-high risk group 126, and high risk group 128 based on the dynamic ranking 102. For example, the dynamic ranking 102 sorts the selected financial asset 130 and the risk groups in order of descending performance, with the best performance at the top of the RAT 100₂ and the worst performance at the bottom of the RAT 100₂. Thus, the selected financial asset 130, having the best performance, in this case 12%, is located at the top of the RAT 100₂ in row entry 110₁. The next highest performance is the medium risk group 124 with 10%, located in row entry 110₂, followed by the low-to-medium risk group 122 with 9%, located in row entry 110₃, followed by low risk group 120 with 4%, located in row entry 110₄, followed by high risk group 128 with 3% in row entry 110₅, and lastly followed by medium-to-high risk group 126 with 1%, which is located in the bottommost row entry 110₆.

The RATs 100₁, 100₂ are configured for being dynamic and can actively change based on various user input. For example, a user can provide an input selecting a different financial asset than the selected financial asset 130, and the RAT 100₂ can rearrange the risk groups 120, 122, 124, 126, and 128 along with the different financial asset to update the RAT 100₂. Similarly, the time period represented in the RAT 100₂ can be changed, and the risk groups 120, 122, 124, 126, and 128 and selected financial asset 130 can be reordered based on new financial data associated with the new time period. The time period represented in RATs may be one or more years, one or more quarters, one or more months, one or more weeks, one or more days, a year-to-date, and any other suitable duration.

The RATs 100₁, 100₂ can also be modified to rank financial assets of different asset categories, for example different share classes of mutual funds, or to rank different types of financial assets, for example exchange-traded funds (ETFs), segregated funds, stocks, bonds, and the like, where permissible by existing regulations. Thus, input from a user of the RATs 100₁, 100₂ can be used to modify or change the information shown in the RATs 100₁, 100₂ in a dynamic fashion. In some embodiments, the RATs 100₁, 100₂ are configured for being modified substantially in real-time.

In some embodiments, the different risk groups are colour-coded according to a particular pattern, with the high risk group 128 being red, the medium-to-high risk group 126 being orange, the medium risk group 124 being yellow, the low-to-medium risk group 122 being green, and the low risk group 120 being blue. Other colour-coding patterns are also considered. Additionally, in certain embodiments, such as the embodiment shown in FIG. 1B, the RAT 100₂ also shows a numerical value for the performance of the selected financial asset 130 and for the risk groups 120, 122, 124, 126, and 128 in the rows 110. In other embodiments, the RAT does not include a numerical value for the performance of the selected financial asset and the risk groups 120, 122, 124, 126, and 128 in the rows 110.

Although the RATs 100₁, 100₂ of FIGS. 1A and 1B have only one column 104, other embodiments of the RAT may include more than one column. With reference to FIG. 10, a third example RAT 100₃ has the first column 104 and a second column 105, each representative of different time periods, as indicated by the column title 106 and column title 107. The time period for the first column 104 may precede the time period for the second column 105, such that the first and second columns 104, 105 are arranged chronologically from left to right. In the RAT 100₃, the performance of the various risk groups 120, 122, 124, 126, and 128 and the selected financial asset 130 over time is shown. Embodiments of the RAT can have any suitable number of columns. In certain embodiments, the RAT 100₃ is configured for being dynamically modifiable to add and/or remove columns, or to modify the time periods represented in the columns. For example, a dropdown menu or other interactive element can be configured to receive input from a user of the RAT 100₃ specifying a time period to be presented by the RAT 100₃, and the RAT 100₃ can change based on the input to present the time periods specified by the user and the user can deselect some or all risk groups and only compare funds that may or may not share the same risk group.

Additionally, in some embodiments an RAT can display more than one selected financial asset. Each of the selected financial assets which are displayed has a graphical element which is shared with the risk group to which the selected financial asset belongs. In embodiments where a supplemental graphical element is applied to or overlaid on the shared graphical element of the selected financial assets, as described hereinabove, different supplemental graphical elements may be applied to each of the selected financial assets. For example, different semi-transparent symbols are applied to each of the selected financial assets. This may be particularly applicable when two or more selected financial assets belong to the same risk group, and thus share the graphical element not only with their risk group but also with one-another.

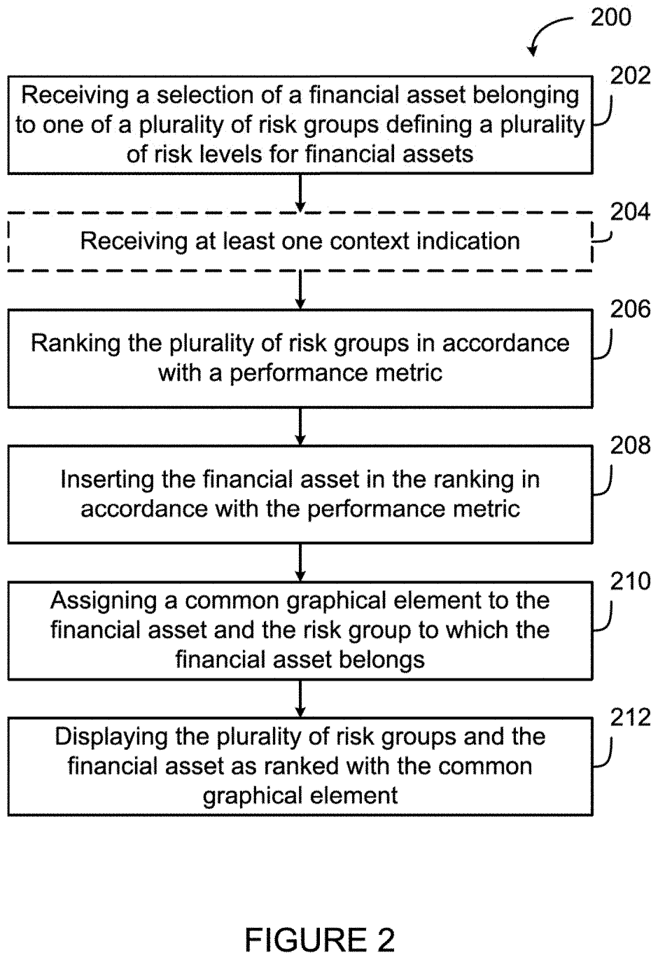

With reference to FIG. 2, a method 200 is provided for producing a RAT, for example any of the RATs 100₁-100₃. At step 202, a selection of a financial asset is received, for example the selected financial asset 130. The selection may be received via one or more input devices, which may be any suitable combination of a mouse, a keyboard, a touchscreen, a joystick, a gamepad, a handheld controller, a voice recognition system, an eye tracking system, a finger tracking system, or any other suitable input device. The financial asset belongs to one of a plurality of risk groups which define a plurality of risk levels for financial assets. For example, the risk groups are the risk groups 220, 222, 224, 226, and 228. In certain embodiments, a plurality of selections are received, each indicating a separate financial asset. In some embodiments, the selected financial assets belong to a common share class and/or mutual fund category; in other embodiments, the selected financial assets belong to disparate share classes and/or categories, where permissible by existing regulations.

Optionally, at step 204, at least one context indication is obtained. The context indications may be indicative of a desired time period for the RAT being generated, whether or not the RAT should display results on a per-term basis or cumulatively over the time period, a subset of risk groups to be displayed in the RAT, a direction for ranking the row entries in the RAT, for example information regarding the dynamic ranking 102, or any other suitable information which can be used in generating the RAT. Additionally, the context indication can specify one or more performance metrics to be displayed in the RAT.

At step 206, the plurality of risk groups are ranked in accordance with the performance metric. The ranking can be performed based on acquired financial data pertaining to the performance for at least some of a plurality of financial assets, which is optionally acquired based on the context indicator. The ranking can be performed based on a predetermined “default ranking”, or can be performed using the context indication which can dictate the order in which to rank the risk groups. The ranking can be performed in any suitable way using any suitable systems and may resemble the RAT 100₁ shown in FIG. 1A.

At step 208, the financial asset is inserted in the ranking in accordance with the performance metric. Thus, the performance of the financial asset is ranked against the performance of the risk groups and based on the performance metric, the financial asset is inserted into the ranking of step 206. For example, this step transforms the RAT 100₁ of FIG. 1A into the RAT 100₂ of FIG. 1B by inserting the selected financial asset 130 into the RAT 100₁ which ranked the risk groups 220, 222, 224, 226, and 228.

At step 210, a common graphical element is assigned to the financial asset and to the risk group to which the financial asset belongs. As shown in the RAT 100₂ of FIG. 1B, both the selected financial asset 130 and the low-to-medium risk group 124 to which the selected financial asset 130 belongs are assigned a common graphical element, in this case a common shading pattern. In other embodiments, the common graphical element can be a colour, a pattern, a shape, a size, and the like.

At step 212, the plurality of risk groups and the financial asset as ranked are displayed with the common graphical element. The plurality of risk groups and the financial asset can be displayed as a RAT via any suitable medium, for example on a screen, via a projector, or on another physical medium. The RAT may be produced in any suitable way, for example using any suitable graphics program.

In some embodiments, the RAT displayed by the method 200 has a dynamic nature and can be modified in response to user input. For example, step 202 can be repeated after step 212 to receive a subsequent selection of a financial asset, and the method 200 can be repeated to modify the RAT. Similarly, step 204 can be repeated after step 212 to receive subsequent context information, for example to change the relevant time period for the RAT or to specify a different list of risk groups to be displayed in the RAT. As another example, both steps 202 and 204 can be repeated to generate a new RAT based on subsequently-received selection and context information.

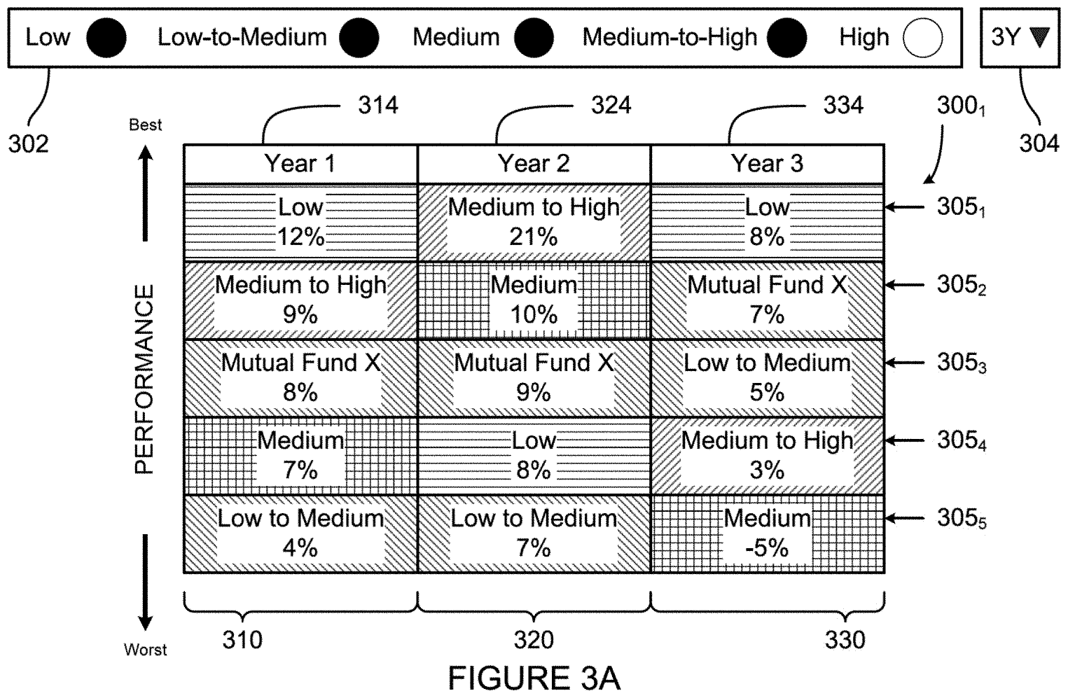

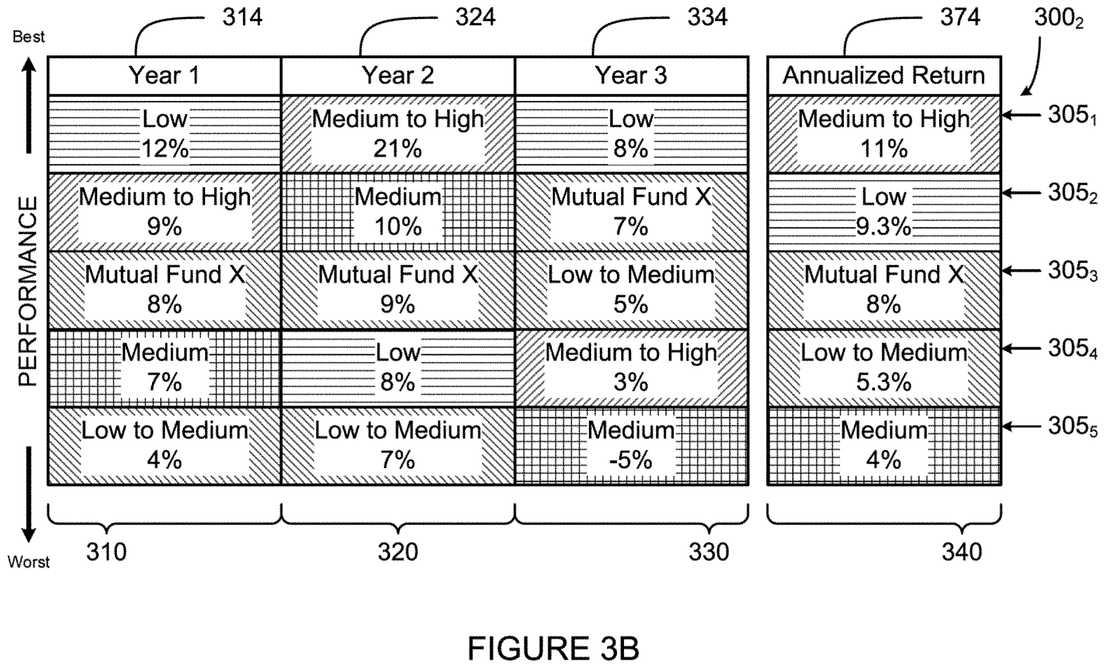

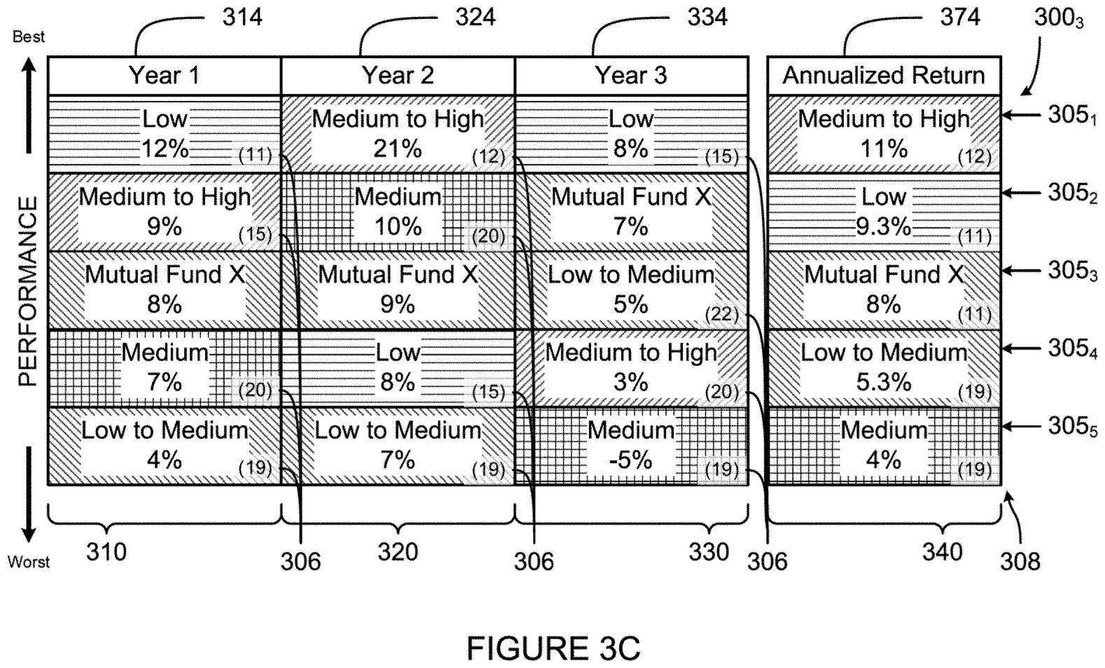

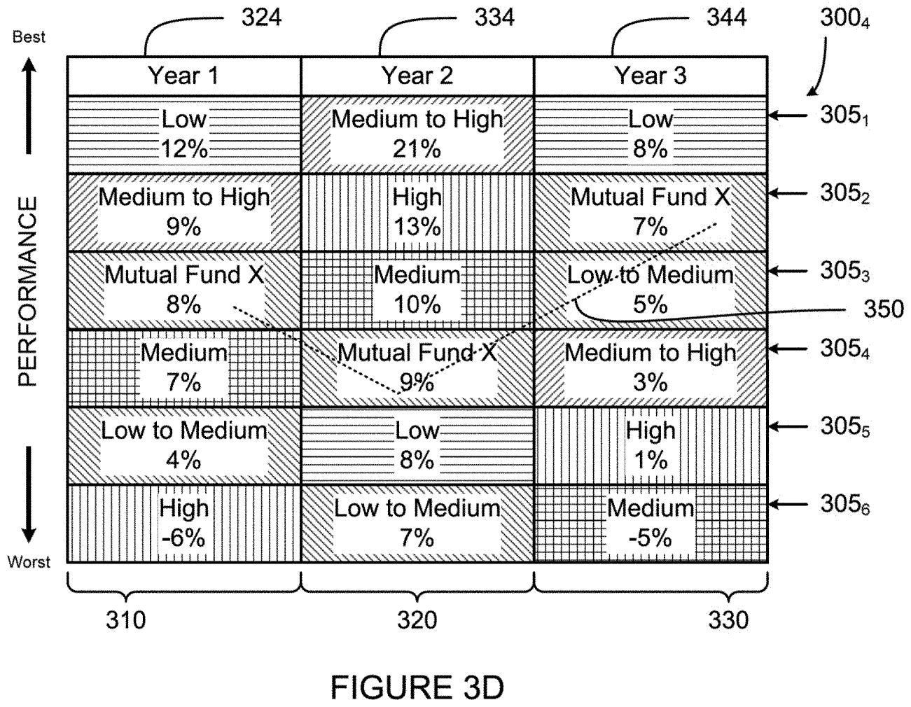

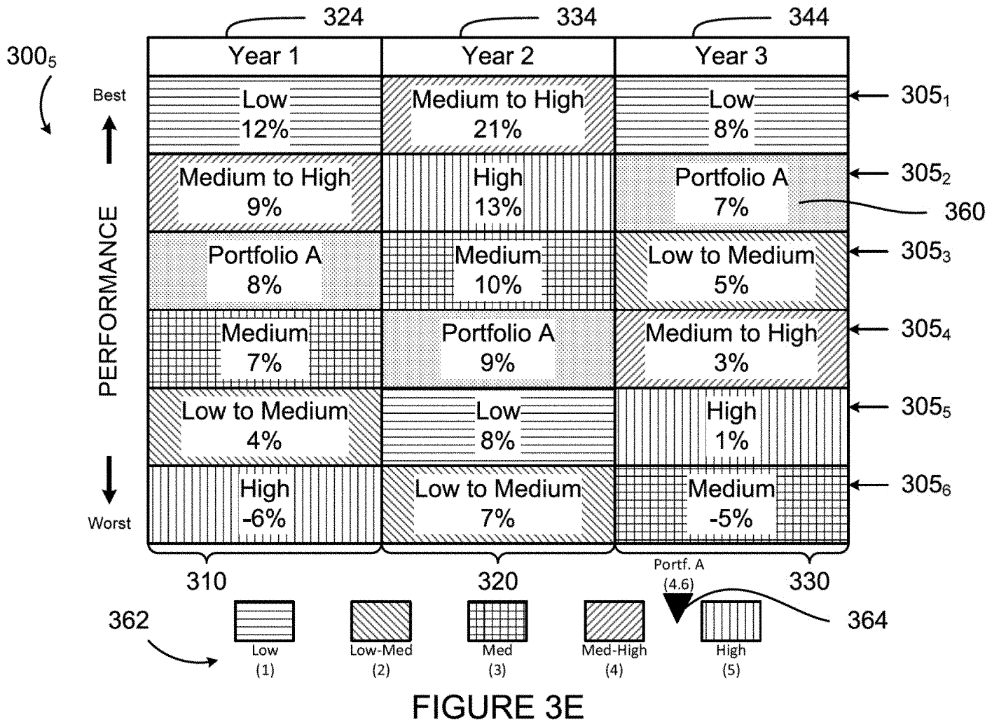

For example, and with reference to FIG. 3A, an embodiment of the RAT 300₁ is displayed in conjunction with a risk bar 302 which sorts risk groups in the risk bar 302 according to the risk levels with which they are associated. The colours may be sorted such that lowest risk is in a leftmost-position on the bar and highest risk is in a rightmost-position on the bar, with lowest risk at the bottom of the bar, and with highest risk at the top of the bar, or in any other suitable fashion. The bar may be positioned in any suitable location with respect to the chart portion of the RAT 300₁, for example above the RAT. By interacting with the risk bar 302, for example by clicking on it with a pointing device, the RAT can be modified to add or remove the risk group with which the interaction occurred. In some embodiments, the interaction with the risk bar 302 is used to remove all the risk groups, leaving only the selected financial asset(s), which continue to have a shared graphical element with their associated risk group even if the risk groups are not displayed. Additionally, the period of time presented in the RAT 300₁ may be modified, for example in response to user input. For example, the RAT 300₁ is displayed in conjunction with a dropdown menu 304 which is indicative of the time period presented in the RAT 300₁. By interacting with the dropdown menu 304, the RAT 300₁ can be modified to present information for the time period specified by the interaction, and/or can set a start or end year for the RAT 300₁. In some embodiments, a sliding scale is provided instead of, or in addition to, the dropdown menu 304. In cases where a particular financial asset did not exist during one or more of the time periods shown in the RAT 300₁, an empty entry of any suitable colour and graphical design may be added to the relevant columns. The empty entry is of a different graphical design than the risk groups, which may avoid confusion with other entries of the RAT 300₁. For example, the empty entry is marked with an “x” symbol or variant thereof.

For example, the RAT 300₁ is shown as having a plurality of columns 310, 320, 330, and a plurality of rows 305₁-305₅. Each of the columns 310, 320, 330 has a respective column title 314, 324, 334, which indicates a time period which the columns 310, 320, 330 each represent. In the example of FIG. 3A, the column 310 represents a first year (“Year 1”), the column 320 represents a second year (“Year 2”), and the column 330 represents a third year (“Year 3”). In the RAT 300₁, the high risk group 128 has been omitted, based on the context information, and thus the RAT 300₁ has only five rows 305₁-305₅.

With reference to FIG. 3B, another embodiment of the RAT 300₂ includes a column 340 which shows average performances over a period of time, such as a sum of the periods of time in the columns of the RAT. For example, the column 340 shows annualized return for the different risk groups and for the selected financial asset. In other embodiments, the column 340 can show calendar year returns, or any other suitable financial performance metric.

With reference to FIG. 3C, another embodiment of the RAT 300₃ includes a plurality of indicators 306 located in each of the risk group entries in the RAT 300₃. The indicators 306 provide additional information relating to the entries in which the indicators 306 are located. For example, in the RAT 300₃, the indicators 306 display a number representative of a total count of financial assets that exist in the risk group with which they are associated for the year in which the entries are placed (i.e., the year indicated in the column titles 314, 324, 334). Additionally, indicators 308 located in column 340, which displays annualized returns, can provide additional information relating to the entries in which the indicators 306 are located, but which is true over the total time illustrated in the RAT 300₃. For example, indicators 308 display a number representative of a total count of financial assets that exist in each risk group for which data is available in all time periods illustrated in the RAT 300₃, in this case Year 1, Year 2, and Year 3. The indicators 306, 308, can also be used to display other information, for example an average age of the financial assets in each risk group, a number of financial asset providers who provide financial assets in each risk group, and the like.

In some embodiments, the indicators 306, 308 appear when interacting with the RAT 300₃, for example via a pointing device or other suitable input device. In addition, the indicators 306, 308 are further configured for other types of interaction which cause a contextual menu to be displayed. In some embodiments, the contextual menu is displayed via an interaction with an interactive button or other element. The contextual menu displays a list of all the financial assets which belong to the risk category of the entry with which an interaction was performed. The list may be sortable, searchable, filterable, and the like, and may display any suitable information, including fund name, fund provider, fund category, fund performance, and the like. The elements of the list may also be configured for being interacted with, for example to add one or more elements to the RAT as a selected mutual fund. In some other embodiments, the contextual menu may be displayed following an interaction with another element located in the entries of the RAT 300₃, for example a relevant symbol or other element. In some other embodiments, the contextual menu display various types of detailed information about the selected financial asset, for example an age, a providing institution, an asset category, and the like.

With reference to FIG. 3D, in some embodiments, the RAT 300₄ additionally includes a trend line 350. The trend line 350 is used to show movement in the relative position of an element of the RAT 300₄, for example the selected financial asset, in this case Mutual Fund X, with respect to the other elements of the RAT 300₄ on a time-period-to-time-period basis. The trend line 350 may be activated by interacting with one of the entries of the RAT 300₄, for example via a pointing device, and may be deactivated by interacting with any suitable portion of the RAT 300₄, for example anywhere other than on the entries which are emphasized via the trend line 350. In addition, although only one trend line 350 is shown in FIG. 3D, it should be noted that additional trend lines can be added, for example by interacting with other entries of the RAT 300₄.

The trend line 350 is traced between different row entries where the selected financial asset Mutual Fund X is found in the columns 310, 320, 330. The trend line 350 may be a solid line, a dashed line, or any other suitable line, and in certain embodiments may be drawn in a colour or pattern which contrasts with other colours used in the RAT 300₄. In certain embodiments, the trend line 350 is curved in order to avoid having the trend line 350 drawn over labels or symbols in the RAT 300₄. In some other embodiments, a highlighting or dimming effect is used to produce the trend line 350. For example, the relevant row entries between which the trend line 350 is traced are coloured differently, brightened, have a halo effect applied thereto, etc. In another example, all row entries aside from the row entries between which the trend line 350 is traced are dimmed or greyed out, and the row entries between which the trend line 350 is traced are left unchanged.

In some embodiments, a trend line can track the progression of a risk group instead of, or in addition to, tracking the progression of the selected financial asset. For example, an additional trend line can be added to the RAT 300₄ to track the progression of a particular risk group, such as the risk group to which the selected financial asset belongs. In some embodiment, the additional trend line can present visual differences compared to the trend line 350 which tracks the selected financial asset. For example the trend line 350 can be a full line, and the additional trend line can be a dashed or dotted line. In addition, the RAT 300₄ may be modifiable to add and/or remove trend lines therefrom, for example in response to a user input.

With reference to FIG. 3E, in another embodiment, illustrated in RAT 300₅, various risk groups can be used as a comparison point for a portfolio, shown at element 360 and called “Portfolio A”. The portfolio 360 can be composed of any suitable number of financial assets, including mutual funds, exchange-traded funds (ETFs), segregated funds, stocks, bonds, and the like, where permissible by existing regulations. In some embodiments, the makeup of the portfolio 360 can be defined by a user of the RAT 300₅ using any suitable tool. In other embodiments, the makeup of the portfolio 360 can be imported from a database or other data storage location, can be based on one or more template portfolios, and the like. The RAT 300₅ ranks the portfolio 360 within the RAT 300₅ alongside the risk groups. Because the portfolio 360 may be composed of financial assets belonging to diverse risk groups, the graphical element associated with the portfolio does not necessarily correspond to the graphical elements associated with the risk groups. As described in greater detail hereinbelow, the graphical element associated with the portfolio 360 can be a combination of multiple graphical elements associated with different risk groups.

In some embodiments, the RAT 300₅ includes a legend 362, which serves, inter alia, to indicate which graphical elements are associated with each of the risk groups. In some instances, the legend 362 also associated each of the risk groups with a particular numerical value: for example, the low risk group can be assigned the numerical value ‘1’, the low-to-medium risk group can assigned the numerical value ‘2’, and so on. The legend 362 can be disposed in a linear fashion, in which the risk group with the lowest numerical value is at one end of the legend 362, and the risk group with the highest numerical value is at the opposite end of the legend 362, with the remaining risk groups disposed therebetween in increasing or decreasing order, as appropriate. In the embodiment illustrated in FIG. 3E, the legend 362 shows the low risk group at the left side of the legend, and the high risk group at the right side, with the low-to-medium, medium, and medium-to-high risk groups arranged in increasing order therebetween.

The legend 362 can also be used to help situate the aggregate risk level of the portfolio 360. The aggregate risk level of the portfolio 360 can be a measure of the overall risk level of the financial assets which compose the portfolio 360. In some cases, the aggregate risk level can be an average of the risk levels of the financial assets composing the portfolio 360, weighted based on the relative composition of the financial assets within the portfolio 360. In order to illustrate the aggregate risk level of the portfolio 360, the legend 362 can include a marker 364 which is labelled “Portf. A”, thereby indicating that it is associated with the portfolio 360. The marker 364 is also labelled with a numerical value indicating the aggregate risk level: in the example of FIG. 3E, the portfolio 360 can have an aggregate risk level of 4.6. Due to the linear disposition of the legend 362, the aggregate risk level of the portfolio 360 can be illustrated on the legend 362 via the marker 364. In this case, the marker 364 is positioned between the medium-to-high element of the legend 362 and the high element of the legend 362. In this fashion, a user of the RAT 300₅ can visualize both the performance of the portfolio 360 and the aggregate risk level of the portfolio 360 relative to the various risk groups.

It should be understood that the RAT 300₅ can be used to visualize more than one portfolio, including via positioning more than one marker 364 along the legend 362. In some embodiments, a graphical element of the marker 364, for instance a colour, gradient, or other visual pattern, can be made to correspond to a graphical element of the portfolio 360 within the RAT 300₅. It should also be understood that other numerical values or valuing schemes can be used for the risk groups, and that other methods for assessing the aggregate risk level of the portfolio 360 are considered.

In addition, the graphical element of the portfolio 360 can be selected to be representative of the aggregate risk level of the portfolio 360 and based on predetermined graphical elements for the risk groups. For instance, Portfolio A illustrated in FIG. 3E has an aggregate risk level of 4.6, as illustrated by the marker 364. If the graphical element associated with the medium-to-high risk group is the colour orange, and the graphical element associated with the high risk group is the colour red, the graphical element used for the portfolio 360 in the RAT 300₅ could use a combination of the colours orange and red. For example, the graphical element could be a gradient, a hatch pattern, a polka-dot pattern, or the like. In another example, the portfolio 360 can be presented with a different colour and include a localized graphical element within, for instance in a smaller box or circle, which uses a combination of the colours orange and red. Still other approaches for graphically representing the portfolio 360 are considered.

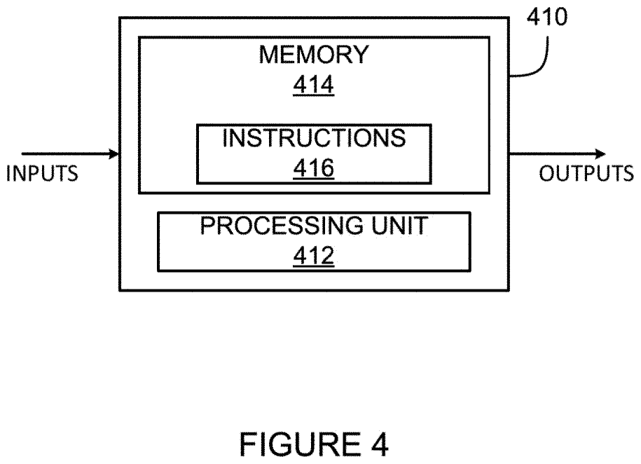

With reference to FIG. 4, the method 200 may be implemented by a computing device 410, comprising a processing unit 412 and a memory 414 which has stored therein computer-executable instructions 416. The processing unit 412 may comprise any suitable devices configured to cause a series of steps to be performed so as to implement the method 200 such that instructions 416, when executed by the computing device 410 or other programmable apparatus, may cause the functions/acts/steps specified in the methods described herein to be executed. The processing unit 412 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 414 may comprise any suitable known or other machine-readable storage medium. The memory 414 may comprise non-transitory computer readable storage medium, for example, but not limited to, an electronic, magnetic, optical, electromagnetic, infrared, or semiconductor system, apparatus, or device, or any suitable combination of the foregoing. The memory 414 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 414 may comprise any storage means (e.g., devices) suitable for retrievably storing machine-readable instructions 416 executable by processing unit 412.

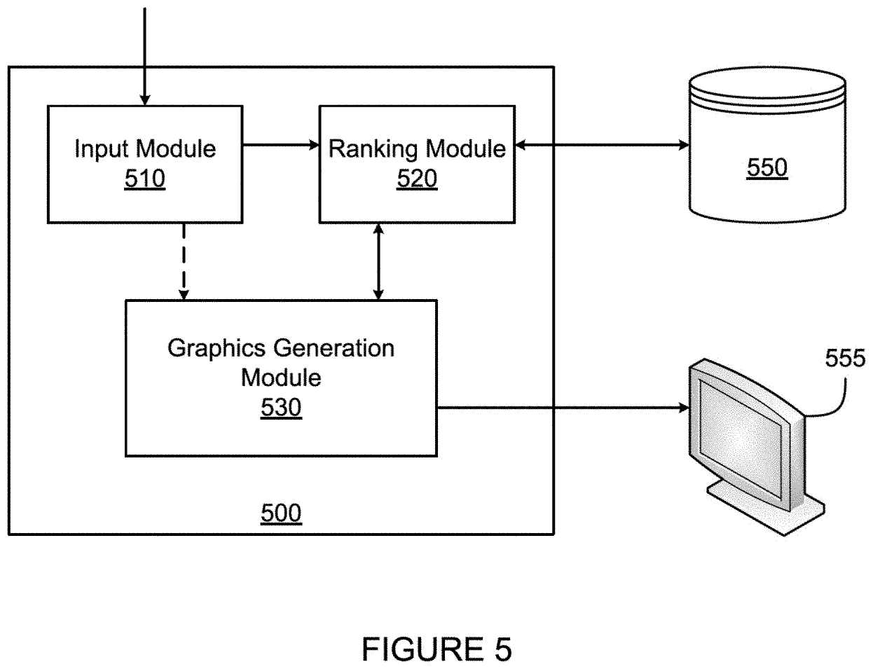

With reference to FIG. 5, a system 500 for generating a risk assessment tool is shown. The system 500 comprises an input module 510, a ranking module 520, and a graphics module 530, and is configured for receiving user input and optionally for communicating with a financial information database 550. Additionally, the system 500 is configured for providing output to a display device 555, which can be any suitable display device, such as a screen, a projector, and the like.

The input module 510 is configured for receiving user input, including a selection of a financial asset, in accordance with step 202. The selected financial asset is one of a plurality of financial assets belonging to a common share class and to one of a plurality of risk groups which define a plurality of risk levels. The input module can receive the selection via any suitable input device, as discussed hereinabove. Alternatively, or in addition, the input module can receive the selection via one or more networks, one or more wired or wireless connections, or via any other suitable path. The input module 510 is configured for sending the selection to the ranking module 520.

Additionally, the input module 510 is optionally configured for obtaining at least one context indication, in accordance with step 204. The context indication can be obtained in much the same way as the selection is obtained. The context indication, as discussed hereinabove, can be indicative of a desired time period for the RAT being generated, whether or not the RAT should display results on a per-term basis or cumulatively over the time period, a subset of risk groups to be displayed in the RAT, a direction for ranking the row entries in the RAT, and the like. The input module 510 is configured to send the context indication to the ranking module 520, and optionally to the graphics module 530. In some embodiments, the input module 510 is configured to store the selection and/or the context indication in an internal database (not illustrated), for example in association with a user ID of the user inputting the selection and/or the context information, and other relevant information, such as timestamps.

The ranking module 520 is configured for receiving from the input module 510 the selection and optionally the context indication. In addition, the ranking module 520 is configured for ranking the plurality of risk groups in accordance with a performance metric, as pet step 206, and for inserting the financial asset in the ranking in accordance with the performance metric, as per step 208. In some embodiments, the ranking module 520 is configured for obtaining financial data from the financial information database 550, the financial data pertaining to the performance metric for financial assets which belong to the same share class as the selected financial asset. The particular financial data obtained from the financial information database 550 may be based on the context indication, if it is provided by the input module 510. Thus, if the context indication specifies a subset of risk groups which should be displayed in the RAT, the financial data obtained from the financial information database 550 may only concern those risk groups which are to be displayed in the RAT. The ranking module 520 is also configured for providing the ranking to the graphics module 530. In some embodiments, the ranking module 520 is also configured to store the ranking in the internal database.

The graphics module 530 is configured for receiving the ranking from the ranking module 520, and optionally for receiving the context indication from the input module 510. The graphics module 530 is also configured for assigning a common graphical element to the selected financial asset and the risk group to which the selected financial asset belongs, in accordance with step 210. The common graphical element can be a colour, a shading, a pattern, and the like, as described hereinabove.

Additionally, the graphics module 530 is configured to display the plurality of risk groups and the financial asset as ranked with the common graphical element, as per step 212. The graphics module may display the plurality of risk groups and the financial asset in the form of a RAT, as discussed hereinabove. In some embodiments, the graphics module 530 also receives the selection and/or the context indication from the input module and/or from the performance metric determination module 530, and generates the RAT based at least in part on the selection and/or the context indication.

The graphics module 530 can use any suitable graphics suite or software to display the RAT based on the performance metric. In some embodiments, the graphics module 530 is configured for displaying the RAT on the display device 555 via any suitable display protocol, including HDMI (High-Definition Multimedia Interface), DisplayPort, and the like, or any suitable wireless display protocol. In other embodiments, the graphics module 530 is configured for displaying the RAT on a screen via a projector. In certain embodiments, the graphics module 530 stores the RAT in the internal database.

In some embodiments, the input module 510 is additionally configured for receiving additional input from a user, which can be a subsequent selection of a financial asset and/or subsequent context information, for modifying an existing RAT. The input module 510 can then provide the subsequent selection and/or subsequent context information to the ranking module 520. The ranking module 520 can use the subsequent selection and/or subsequent context information to update the ranking of the plurality of risk groups and the financial asset in accordance with the performance metric and/or to modify visual aspects of the RAT, for example by adding and/or removing trend lines or altering colours assigned to the different risk groups. The ranking module 520 can then provide the updated ranking to the display module 530, which can update the RAT based on the updated ranking.

The RAT provides a user with a simple yet striking visual representation of the rates-of-return for different risk groups and for one or more selected financial asset. All relevant information for evaluating the performance of the selected financial asset as compared to the different risk groups is provided in a single location. Extraneous information is stripped away in order to focus on the performance of the selected financial asset compared to the risk groups. The RAT thus serves as a risk assessment tool in that a user may consider his or her own risk profile using different inputs. Indeed, the dynamic nature of the RAT allows a user to visualize different scenarios, for example by adding and/or removing selected financial assets or risk groups, or by altering the time period shown in the RAT. This allows the user to consider different factors and to observe how common investing trends, such as 3-year growth, 5-year growth, and the like, change over time. In addition, the RAT allows the user can identify the variance of returns over time for each risk group and/or financial asset, helping the user determine how much volatility of risk he or she is willing to accept. The user therefore acquires a better appreciation of the potential risks and rewards associated with the different risk groups, beyond simply the words “low”, “medium”, and “high”. Users can then assess for themselves which level of risk they are comfortable in taking on, and in this way move toward determining a more accurate risk profile.

The particular graphical structure of the RAT, including the graphical element shared by the selected financial asset and the risk group to which the selected financial asset belongs, serves to augment the functionality of the RAT. The presence of one or more common graphical elements between the selected financial asset and the associated risk group contrasts the performance of the selected financial asset over time versus the different risk groups, and highlights patterns and/or outliers over periods of time. It also creates a link between two specific items displayed to the user, as a constant reminder that the selected financial asset, which may be a financial asset that the user is considering to acquire or currently has in a financial portfolio, belongs to one of the risk groups also displayed. When visualizing a selected financial asset that has performed particularly well but is part of a risk group that has performed particularly poorly, the constant reminder of the relationship is even more important than when visualizing a selected financial asset whose performance is similar to that of its associated risk group. The shared graphical element for the selected financial asset and the risk group to which the selected financial asset belongs thus allows the user to make a rapid and straightforward comparison between the performance of the selected financial asset and that of the risk group to which the selected financial asset belongs as well as to the other risk groups.

The RAT therefore offers improved readability and usability over the questionnaires used to assess a risk profile. The RAT allows the user to determine more quickly and with greater accuracy what risk groups and which financial assets are most suited for his or her own risk profile. In addition, the user may perform his or her own risk profile assessment instead of relying on the conclusions of another party drawn from the answers to a risk assessment questionnaire. The functionality of providing an understanding of the risk and rewards associated with each risk group is not afforded by the risk assessment questionnaires used in general investment practice. The RAT offers a comparison of a particular financial asset's performance against the averages of risk groups within the same share class, and in some cases a comparison against one or more other funds in the same share class.

The methods and systems for operating a financial tool described herein may be implemented in a high level procedural or object oriented programming or scripting language, or a combination thereof, to communicate with or assist in the operation of a computer system, for example the computing device 410. Alternatively, the methods and systems for operating a financial tool may be implemented in assembly or machine language. The language may be a compiled or interpreted language. Program code for implementing the methods and systems for operating a financial tool may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for operating a financial tool may also be considered to be implemented by way of a non-transitory computer-readable storage medium having a computer program stored thereon. The computer program may comprise computer-readable instructions which cause a computer, or more specifically the processing unit 412 of the computing device 410, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. For example, multiple selected financial assets can be presented in a single RAT. Still other modifications which fall within the scope of the present invention will be apparent to those skilled in the art, in light of a review of this disclosure.

Various aspects of the method and system for operating a financial tool disclosed herein may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the preferred embodiments set forth in the examples, but should be given the broadest reasonable interpretation consistent with the description as a whole.

1. A method for operating a financial tool, the method comprising:
receiving a selection of a financial asset, the financial asset belonging to one of a plurality of risk groups defining a plurality of risk levels for financial assets;
ranking the plurality of risk groups in accordance with a performance metric;
inserting the financial asset in the ranking in accordance with the performance metric;
assigning a common graphical element to the financial asset and the risk group to which the financial asset belongs; and
displaying the plurality of risk groups and the financial asset as ranked with the common graphical element.

2. The method of claim 1, wherein the financial asset is one of a mutual fund, a segregated fund, and an Exchange-Traded Fund.

3. The method of claim 1, wherein the performance metric is a rate-of-return over a period of time.

4. The method of claim 1, wherein the risk groups are regulation-compliant.

5. The method of claim 1, wherein the common graphical element is a colour.

6. The method of claim 1, wherein displaying the plurality of risk groups and the financial asset as ranked comprises displaying a chart with a plurality of rows, at least one column, and defining a plurality of cells, each of the at least one columns being representative of a respective time period, and each cell having a respective label indicative of one of one of the risk groups and the financial asset.

7. The method of claim 6, wherein each risk group is colour-coded, wherein displaying the plurality of risk groups and the financial asset as ranked further comprises displaying a risk bar which sorts the colours according to the risk levels from lowest to highest.

8. The method of claim 7, wherein displaying the plurality of risk groups and the financial asset as ranked further comprises displaying an additional column defining a second plurality of cells, each of the second plurality of cells representative of an average.

9. The method of claim 7, wherein displaying the plurality of risk groups and the financial asset as ranked further comprises overlaying a trend line connecting cells having the labels indicative of the financial asset.

10. The method of claim 1, wherein displaying the plurality of risk groups and the financial asset further comprises hiding at least one of the plurality of risk groups.

11. The method of claim 1, further comprising changing a time period associated with the ranking.

12. The method of claim 1, further comprising:
subsequent to displaying the plurality of risk groups and the financial asset, receiving an input indicative of deselecting the risk groups; and
displaying the financial asset as ranked with the common graphical element.

13. The method of claim 1, wherein displaying the plurality of risk groups and the financial asset as ranked comprises displaying a plurality of interactive elements each associated with a respective one of the plurality of risk groups, the method further comprising, in response to detecting an interaction with one of the plurality of interactive elements, displaying a contextual menu.

14. The method of claim 13, wherein displaying the contextual menu comprises displaying at least one supplementary interactive element, the method further comprising:
in response to detecting a supplementary interaction with one of the at least one supplementary interactive elements:
receiving a selection of a supplementary financial asset based on the supplementary interaction;
inserting the supplementary financial asset in the ranking in accordance with the performance metric;
assigning a supplementary common graphical element to the supplementary financial asset based on the risk group to which the financial asset belongs; and
displaying the plurality of risk groups, the financial asset, and the supplementary financial asset as ranked with the common graphical element and the supplementary common graphical element.

15. A system for operating a financial tool, the system comprising:
a processing unit; and
a non-transitory memory communicatively coupled to the processing unit and comprising computer-readable program instructions executable by the processing unit for:
receiving a selection of a financial asset, the financial asset belonging to one of a plurality of risk groups defining a plurality of risk levels for financial assets;
ranking the plurality of risk groups in accordance with a performance metric;
inserting the financial asset in the ranking in accordance with the performance metric;
assigning a common graphical element to the financial asset and the risk group to which the financial asset belongs; and
displaying the plurality of risk groups and the financial asset as ranked with the common graphical element.

16. The system of claim 15, wherein the financial asset is one of a mutual fund, a segregated fund, and an Exchange-Traded Fund.

17. The system of claim 15, wherein the performance metric is a rate-of-return over a period of time.

18. The system of claim 15, wherein the risk groups are regulation-compliant.

19. The system of claim 15, wherein the common graphical element is a colour.

20. The system of claim 15, wherein displaying the plurality of risk groups and the financial asset as ranked comprises displaying a chart with a plurality of rows, at least one column, and defining a plurality of cells, each of the at least one columns being representative of a respective time period, and each cell having a respective label indicative of one of one of the risk groups and the financial asset.

21. The system of claim 20, wherein each risk group is colour-coded, wherein displaying the plurality of risk groups and the financial asset as ranked further comprises displaying a risk bar which sorts the colours according to the risk levels from lowest to highest.

22. The system of claim 21, wherein displaying the plurality of risk groups and the financial asset as ranked further comprises displaying an additional column defining a second plurality of cells, each of the second plurality of cells representative of an average.

23. The system of claim 20, wherein displaying the plurality of risk groups and the financial asset as ranked further comprises overlaying a trend line connecting cells having the labels indicative of the financial asset.

24. The system of claim 15, wherein displaying the plurality of risk groups and the financial asset further comprises hiding at least one of the plurality of risk groups.

25. The system of claim 15, the computer-readable program instructions being further executable by the processing unit for changing a time period associated with the ranking.

26. The system of claim 15, the computer-readable program instructions being further executable by the processing unit for:
subsequent to displaying the plurality of risk groups and the financial asset, receiving an input indicative of deselecting the risk groups; and
displaying the financial asset as ranked with the common graphical element.

27. The system of claim 15, wherein displaying the plurality of risk groups and the financial asset as ranked comprises displaying a plurality of interactive elements each associated with a respective one of the plurality of risk groups, the computer-readable program instructions being further executable by the processing unit for, in response to detecting an interaction with one of the plurality of interactive elements, displaying a contextual menu.

28. The method of claim 27, wherein displaying the contextual menu comprises displaying at least one supplementary interactive element, the computer-readable program instructions being further executable by the processing unit for:
in response to detecting a supplementary interaction with one of the at least one supplementary interactive elements:
receiving a selection of a supplementary financial asset based on the supplementary interaction;
inserting the supplementary financial asset in the ranking in accordance with the performance metric;
assigning a supplementary common graphical element to the supplementary financial asset based on the risk group to which the financial asset belongs; and
displaying the plurality of risk groups, the financial asset, and the supplementary financial asset as ranked with the common graphical element and the supplementary common graphical element.

29. A financial tool comprising:
a processing unit configured for:
receiving a selection of a financial asset, the financial asset belonging to one of a plurality of risk groups defining a plurality of risk levels for financial assets;
ranking the plurality of risk groups in accordance with a performance metric;
inserting the financial asset in the ranking in accordance with the performance metric; and
assigning a common graphical element to the financial asset and the risk group to which the financial asset belongs; and
a display for displaying the plurality of risk groups and the financial asset as ranked with the common graphical element.

30. A method for operating a financial tool, the method comprising:
receiving an indication of a portfolio composed of a plurality of financial assets, each of the financial assets belonging to one of a plurality of risk groups defining a plurality of risk levels for financial assets, the portfolio being associated with an aggregate risk level based on the risk groups to which the plurality of financial assets belong;
ranking the plurality of risk groups in accordance with a performance metric;
inserting the portfolio in the ranking in accordance with the performance metric;
assigning a graphical element to the portfolio that is representative of the aggregate risk level of the portfolio, the graphical element based on predetermined graphical elements associated with at least one of the risk groups; and
displaying the plurality of risk groups and the financial asset as ranked with the graphical element.
